(19) United States
(12) Patent Application Publication
(10) Pub. No.: US 2001/0034678 A1
(43) Pub. Date: Oct. 25, 2001

(54) Electronic purchase and sale of securities system and method

(75) Inventors: Joseph Lerner, Arlington, VA (US); Jerome Szelc, Sterling, VA (US); Stewart Christ, Herndon, VA (US); James Currier, Bloomfield Hills, MI (US); Carl Enroth, Arlington, VA (US); John Roehling, Rochester Hills, MI (US)

Correspondence Address: GREENBERG-TRAURIG, 1750 TYSONS BOULEVARD, 12TH FLOOR, MCLEAN, VA, 22102, US

(73) Assignee: Online investments, Inc., Reston, VA (US)

(21) Appl. No.: 09/726,793

(22) Filed: Dec. 1, 2000

Related U.S. Application Data
(60) Provisional application No. 60/168,185, filed on Dec. 1, 1999.

(51) Int. Cl. G06F 17/60

(52) U.S. Cl. 705/35

(57) ABSTRACT

A personal, customized, diversified securities fund may be created and managed through a World Wide Web site (“web site”). The web site in its preferred embodiment allows a customer to indicate individual companies, governments, or other entities in whose securities the customer would like to invest, and a dollar amount to be invested in each entity. The web site preferably also allows a customer to sell fixed dollar amounts of a specific security, to transfer securities held under one account into another, or to transfer securities to or from another brokerage. The system may periodically consolidate purchase requests into discrete sets of aggregate stock buy, sell, or transfer orders. A licensed broker/dealer may then use the consolidated orders to buy, sell, or transfer appropriate numbers of securities. When a broker/dealer has bought, sold, or traded shares, a purchase or sale price of each security involved may be transmitted to the system. Using pricing information, the system computes whole and fractional shares owned by a customer, any funds owed, and any funds due. A customer account may be credited or debited based on calculation results.

### PRIORITY CLAIM

The present invention claims the benefit of U.S. Provisional Patent Application No. 60/168,185, filed Dec. 1, 1999, the entire disclosure of which is incorporated by reference herein, including all appendices.

### FIELD OF THE INVENTION

The present invention relates to electronic securities purchase, sale, and exchange. In particular, a preferred embodiment of the invention provides a system and method which allows individual investors to buy and sell stocks, bonds, and other securities on-line.

### BACKGROUND OF THE INVENTION

The global economic stability of the past decade has encouraged a record number of investors to enter the stock market. Most new investors enter the market through funds, which new investors choose because funds offer high rates of return, broad diversification, and low initial investments.

A traditional fund may consist of a group of securities selected by a fund manager from across the entire market. A broad-market, or diversified, approach is typically advantageous due to stability provided by other portions of the market when a particular sector of the market experiences problems.

However, investors are increasingly interested in selecting individual companies, municipalities, or other entities in which they invest, which cannot be done with a traditional fund. As more people connect to the Internet, a number of both new and current investors are turning to on-line brokerage houses to facilitate investing in individual entities. Opening an account with an on-line brokerage allows an investor to electronically create and manage a portfolio matching a particular investment style.

One limitation associated with creating an account with a brokerage is that a brokerage account typically requires a substantial initial investment, which puts investing with a brokerage house out of reach of a typical new investor. In addition, traditional securities models allow for only whole share purchases, and many of the more stable, or “blue chip” stocks, are priced at levels that are cost prohibitive, especially for new investors. The high cost of “blue chip” stocks, as well as the large initial investment required to open an account with a brokerage house make diversification difficult, if not impossible, for a new investor outside of a mutual fund.

### SUMMARY OF THE INVENTION

The present invention provides an electronic method for creating and maintaining a “personal fund” by allowing fractional portions of securities to be purchased. A personal fund allows customers to carefully select securities to be part of their fund, while still allowing a customer to diversify without requiring a substantial initial investment. The invention allows customers to electronically create and manage their own customized, diversified securities fund via a world wide web site, through which a customer may indicate individual entities in whose securities the customer would like to invest, and a dollar amount to be invested in each entity. The world wide web site may also allow a customer to sell fixed dollar amounts of a specific security, to sell whole or fractional shares of a security, and to transfer securities held under one account into another.

The system in its preferred embodiment periodically consolidates customer buy, sell, or transfer requests, which may be stored in a temporary location, into discrete sets of whole-share transactions. If the system is not managed by a licensed broker/dealer, the system may transmit a consolidated transaction to a broker/dealer or multiple broker/dealers. A broker/dealer may then buy, sell, or transfer an appropriate number of shares.

In the preferred embodiment, when a broker/dealer has completed a transaction or set of transactions, the purchase or sale price of each security is transmitted to the system. Using pricing and ownership information, the system divides any securities purchased into fractional shares and distribute those shares, along with any additional fees, such as transaction fees, to customer accounts. The system may also use pricing and ownership information to distribute any transaction costs to the appropriate customers.

The system may also debit either a customer bank account, payroll deposit, or other source of funds on a scheduled basis. Scheduled transactions allow customers to invest without having to remember to take any action.

The system, either in whole or in part, may also be licensed to others to allow creation of custom interfaces to underlying securities data. For example, a company may license the system for use by its employees as part of a 401(k) plan or other savings or investment vehicle provided by the company.

### BRIEF DESCRIPTION OF THE DRAWINGS

FIG. 1 is a block diagram illustrating the major software components of a preferred embodiment of the present invention.

FIG. 2 is a block diagram illustrating a preferred embodiment of the process by which shares are bought and sold.

FIG. 3(a) is a representative sample of the on-line user interface used to create a customer account.

FIG. 3(b) is a representative sample of the on-line user interface used to create a customer account.

FIG. 3(c) is a representative sample of the on-line user interface used to create a customer account.

FIG. 3(d) is a representative sample of the on-line user interface used to create a customer account.

FIG. 3(e) is a representative sample of the on-line user interface used to create a customer account.

FIG. 3(f) is a representative sample of the on-line user interface used to create a customer account.

FIG. 4 is a representative sample of the on-line user interface used to purchase whole or fractional shares.

FIG. 5 is a representative sample of the on-line user interface used when configuring the automated investment feature.

FIG. 6 is a representative sample of an on-line account summary.

### DETAILED FUNCTIONAL DESCRIPTION OF THE INVENTION

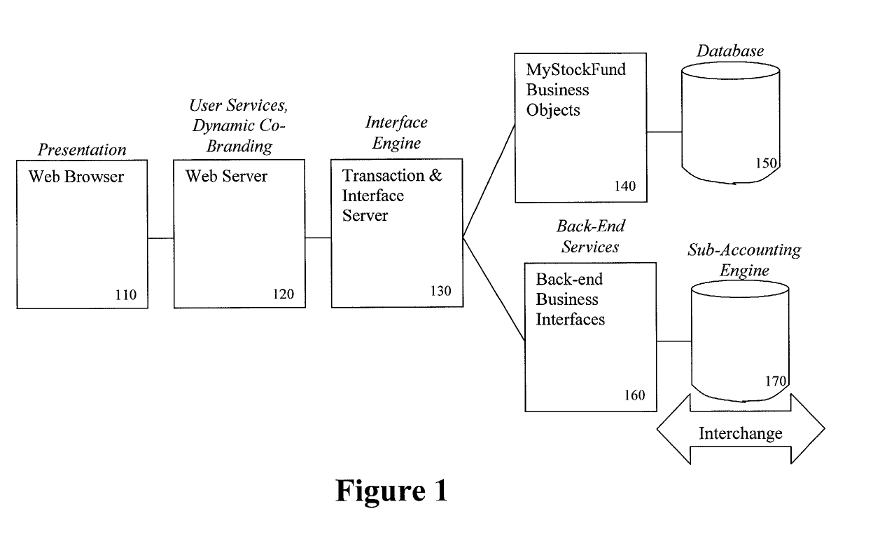

FIG. 1 is a block diagram illustrating the major software components of a preferred embodiment of the present invention, providing a functional overview of the present invention. Block 110 represents a typical World Wide Web browser (“Web Browser”), such as Internet Explorer, manufactured by Microsoft of Seattle, Washington, or Netscape Navigator, manufactured by Netscape of Mountain View, California. Web Browser 110 may be used to present information to or solicit responses from a customer.

Block 120 represents a typical World Wide Web server (“Web Server”), such as Microsoft's Internet Information Server, Netscape's Enterprise Server, or Apache Server, manufactured by The Apache Software Foundation of Lincoln, Nebraska. Web Server 120 may be used to generate reports delivered to a customer, or to receive user inputs. Web Server 120 may also handle information display customization, including, but not limited to, changing a visual representation of a document to match those specified by either a customer (“User Services”) or a licensee of the system (“Dynamic Co-Branding”). Web Server 120 may also act as an interface to Transaction and Interface Server 130 (“Interface Engine”). When Web Server 120 receives a request for a specific report from a customer, Web Server 120 may request data for that report from Interface Engine 130.

Interface Engine 130 interacts with MyStockFund Business Objects 140 (“Business Objects”) and Back-End Business Interfaces 160 (“Back-End Services”). When a customer edits an account, Business Objects 140 determines customer information, such as a customer's name, address, social security number, and the like, from Database 150. Database 150 can consist of one or more database servers. Data stored in Database 150 can be distributed among physical disk drives (“striped”), housed on multiple database servers (“mirrored”), or both striped and mirrored. Data stored in Database 150 may be compressed or encrypted, or Database 150 may store its data in an uncompressed and/or unencrypted format. Further, Database 150 may store content as files external to a database, or content may be stored internal to a database.

Information retrieved from Database 150 may then be returned to Interface Engine 130. Interface Engine 130 may also request information from Back-End Services 160, which provides an interface to Sub-Accounting Engine 170.

Sub-Accounting Engine 170 may be used to maintain securities records within each account, such as, but not limited to, whole and partial securities ownership; any transactional information, such as recent purchases or sales; and reinvestment preferences. Sub-Accounting Engine 170 may also generate reports, confirmation codes, or other information destined for a customer. In a preferred embodiment, Sub-Accounting Engine 170 consists of a combination of computers, with Intel-based CPU's and the Windows NT Server operating system and Internet Information Server web server, and one or more databases for storing sub-account information. Such databases are similar to those used in Database 150.

Information from Sub-Accounting Engine 170 may be returned to Interface Engine 130, which may consolidate data from Business Objects 140 and Back-End Services 150. Interface Engine 130 may then pass such consolidated data to Web Server 120 for display.

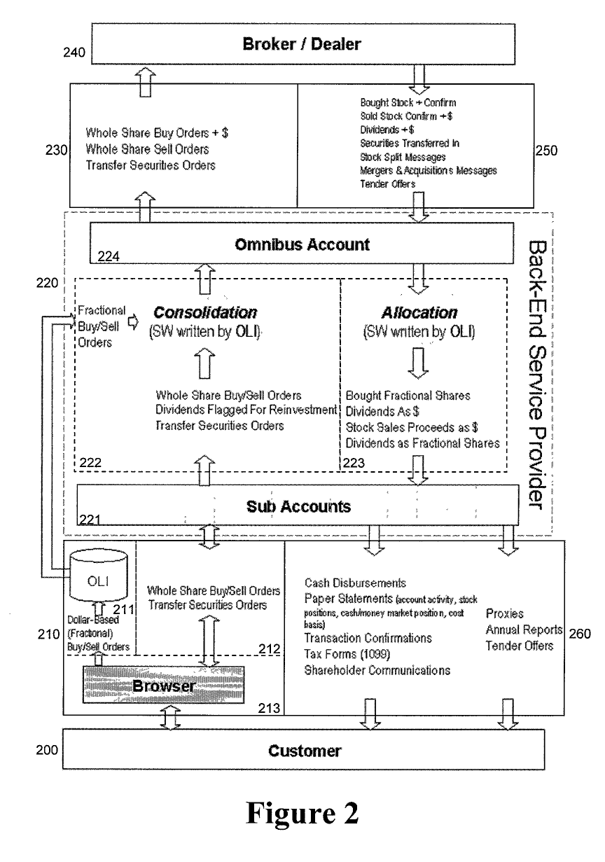

FIG. 2 is a block diagram illustrating a process by which securities can be bought and sold. Customer 200 initiates buy, sell, or transfer requests; requests and receives reports; and receives cash disbursements, tax forms, and other paper and electronic correspondence from the system. Block 210 represents an electronic interaction between Customer 200 and Back-End Service Provider 220.

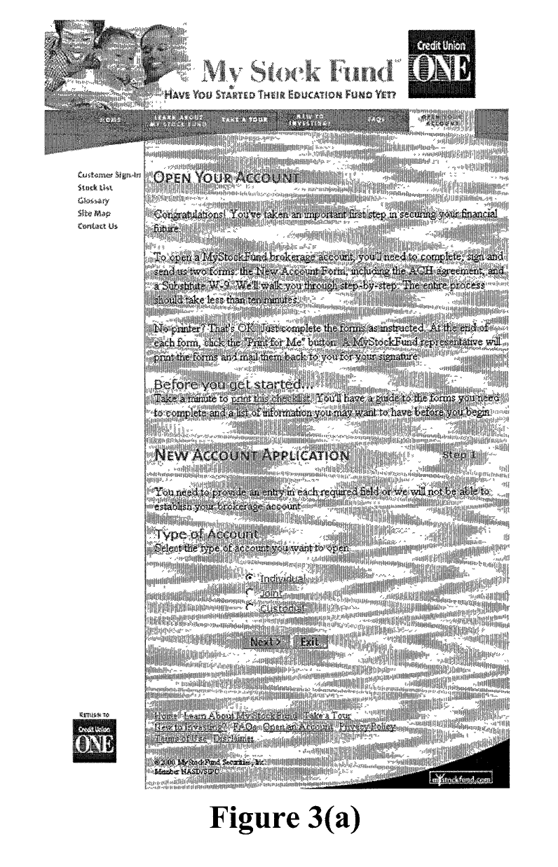

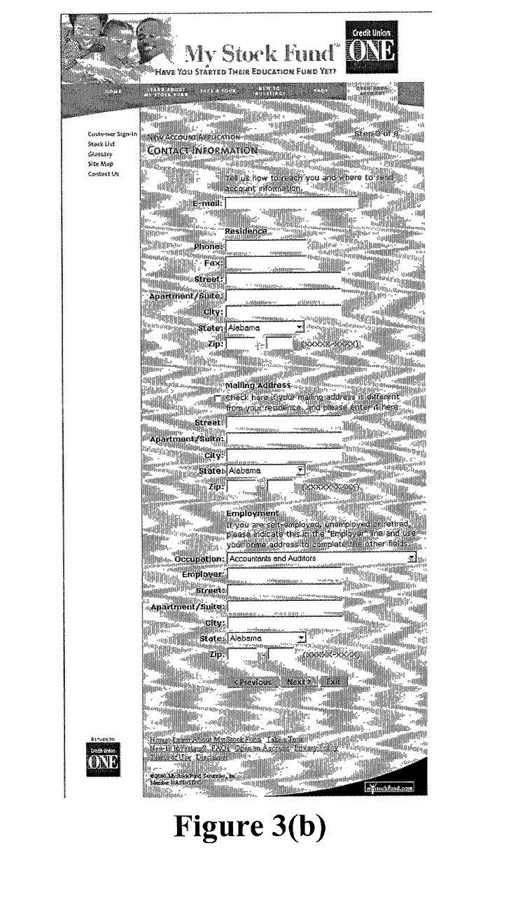

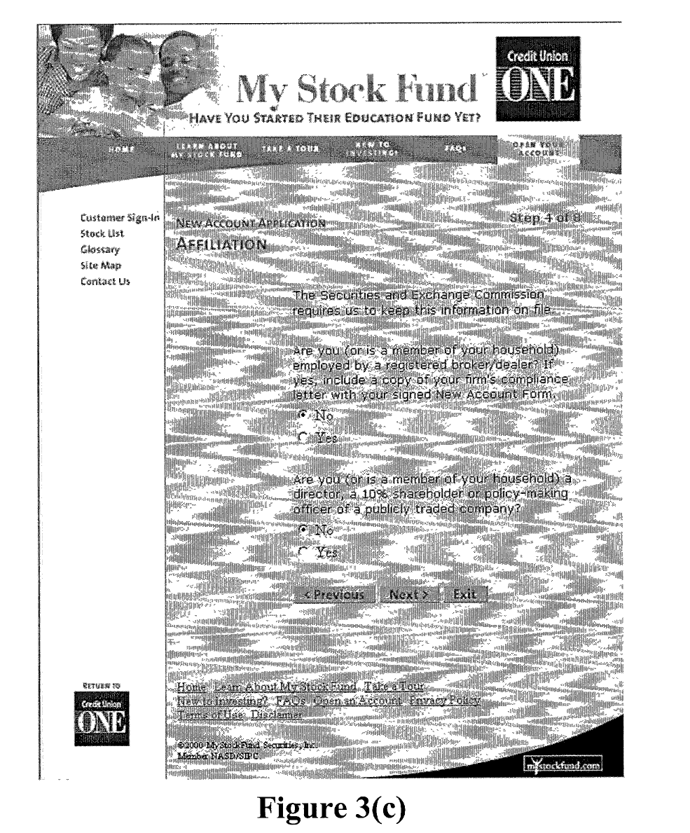

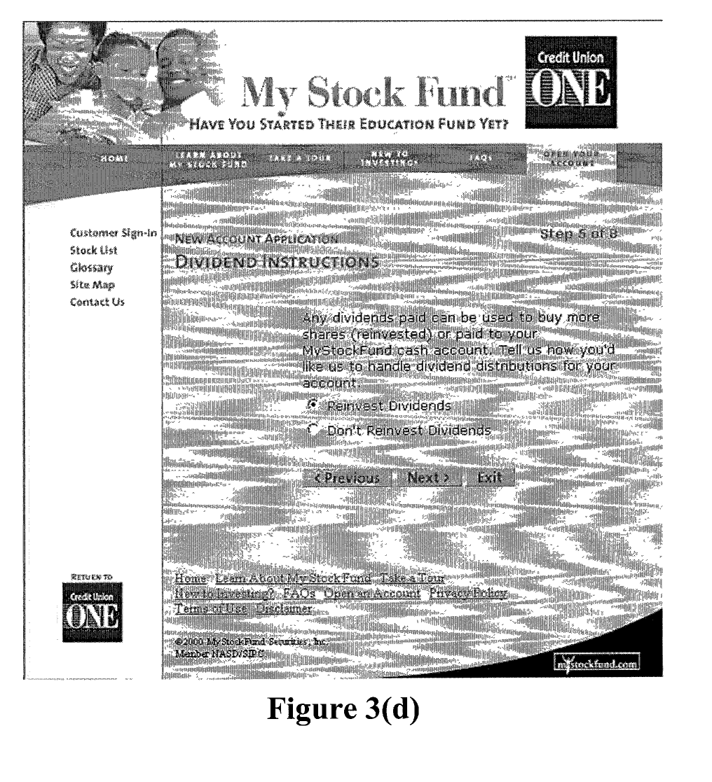

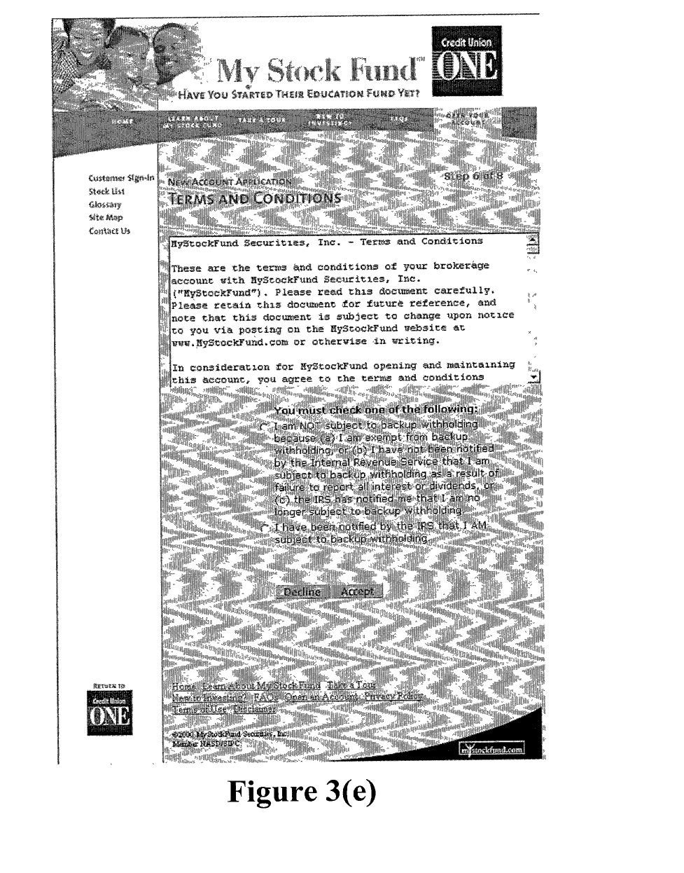

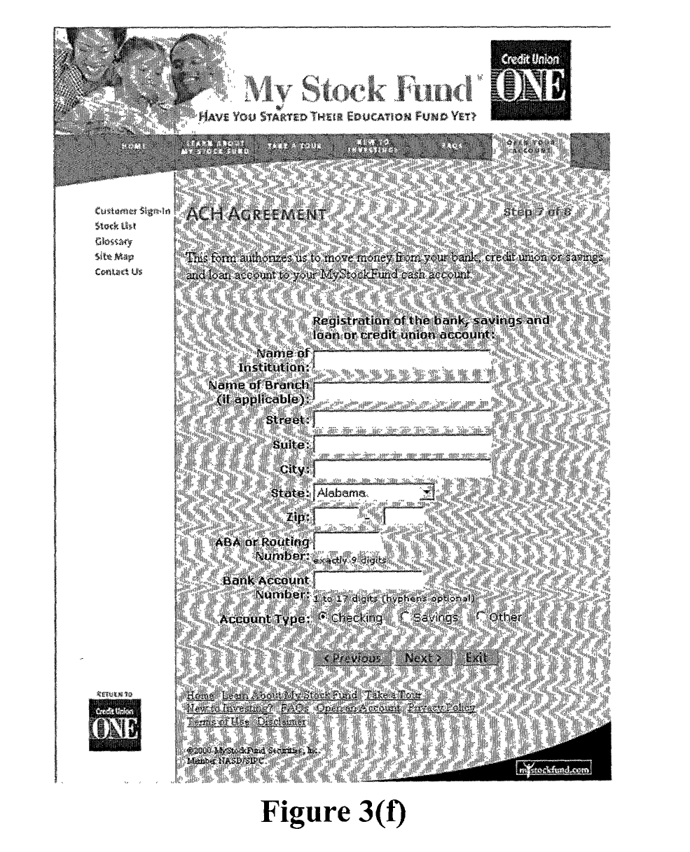

Web Browser 213 can act as an interface layer between the system and the customer, and may be used by a customer to enter a request to buy, sell, or transfer securities; to request a report; and for other such purposes. A representative sample of a user interface for account creation is illustrated by FIGS. 3(a) through 3(f).

FIGS. 3(a), through 3(f) represent a typical form that a customer may see when creating an account. A customer may print a blank form, fill in required fields, including, but not limited to, requisite Securities and Exchange Commission disclosures, and mail a signed copy to a recipient. A customer may also electronically submit and sign a completed form using a “digital signature”, or a customer may submit a partially or fully competed form for manual signing. By electronically submitting a partially or fully completed form without a digital signature, a representation of the data that may be more easily printed may appear on the screen. A signed copy of a completed form may be mailed by standard postal mail.

Once an account has been created, an investor can specify fixed dollar amounts to be invested in a given security, or a number of shares of a security to be purchased. If a fixed dollar amount of a particular security is to be bought or sold, or a sale includes fractional shares, the dollar amount information and/or fractional portion of shares may be routed through Dollar/Fractional Interface 211. Dollar/Fractional Interface 211 may convert any fixed dollar amount sales to whole and fractional share sales, consolidate converted data with additional fractional share information which may have been passed to it, and pass resulting purchase data to Consolidation Engine 222.

Consolidation Engine 222 may accumulate buy, sell, and trade orders and calculate securities totals for each stock buy, sell, or trade order. For n customers, the total number of securities to be purchased is equal to the number of shares required to give each customer the dollar amount requested, which may be expressed as an equation as shown in Equation 1.

$$RoundUp ( {{\sum }_{1}}^{n} \frac{Customer Amount}{StockShare Price} ) \qquad ( 1 )$$

A similar calculation may be performed when a customer requests that a specific dollar amount of a security be sold or traded; for n customers, the total number of securities to be sold is equal to the number of securities required to give each customer the dollar amount requested, which may be expressed as an equation as shown in Equation 1.

Any whole share sales involved in buy, sell, or trade transactions may be sent directly through Whole Share Buy/Sell Orders 212 to Sub-Account Interface 221.

Sub-Account Interface 221 may provide standardized access to an underlying account structure. The present invention may store securities maintained by the system in Omnibus Account 224, although other storage architectures, such as separate accounts for whole-share holders, may also be used. Each share stored in Omnibus Account 224 has a corresponding set of one or more “owners”, and maintenance of ownership records may be one responsibility of Sub-Account Interface 221.

For example, Sub-Account Interface 221 may track securities as they are purchased or transferred into an account, including, but not limited to fractional and whole share allocation, dividend reinvestment, and account balances. When a stock is sold or transferred from an account, Sub-Account Interface 221 may perform whole and fractional share allocation, dividend allocation, dividend reinvestment, and proceed disbursement.

Once any fractional shares have been calculated and an account has been properly updated through Sub-Account Interface 221, data may be passed to Consolidation Engine 222. Consolidation Engine 222 may execute securities sales or purchases which can be accommodated through securities held in Omnibus Account 224, but which are not assigned to an individual investor. Consolidation Engine 222 may facilitate such transactions by requesting current securities prices from Broker/Dealer 240 (this process is illustrated by Blocks 240 and 250 in FIG. 2). Such prices can then be used by Consolidation Engine 222 to calculate appropriate costs and to transfer securities to an appropriate investor.

Consolidation Engine 222 may also accumulate purchase, sale, and transfer requests which it cannot fulfill from the Omnibus Account until an event occurs, such as accruing a minimum number of requests, a certain period of time elapsing, or reaching a specific date or time. When a buy request is received, Consolidation Engine 222 may transfer a cash balance from a direct payroll deduction, automated bank-account withdrawal, or other means. Funds transferred to Consolidation Engine 222 may be moved from cash to money market while awaiting a consolidation event.

Further, Consolidation Engine 222 may sell excess whole shares which are held beyond a specific period without being purchased by investors using the present invention during a consolidation event. This allows the present invention to keep only those shares necessary to fulfill investor requirements.

When consolidation events occur, a consolidated purchase, sale, and/or transfer request may be sent to Broker/Dealer 240. Broker/Dealer 240 may accommodate any requests by either selling, purchasing or transferring appropriate securities from Omnibus Account 224 (this process is illustrated by Block 230 in FIG. 2). Broker/Dealer 240 may also transmit the sale or purchase price, along with other related securities information, back to Omnibus Account 224 (this process is illustrated by block 250 in FIG. 2). Any new securities purchased can then be stored in Omnibus Account 224 for distribution.

After Omnibus Account 224 receives securities information from Broker/Dealer 240, such information may be transferred to Allocation Engine 223. Allocation Engine 223 may perform calculations based on this information, including, but not limited to, allocating whole and fractional to individual purchasers, dividends for whole and fractional share owners, and securities sales proceeds. Allocation Engine 223 can also send pricing and other securities and account information back to Sub-Account Interface 221. Such information may be used by Sub-Account Interface 221 to credit or debit a customer's account as appropriate, or for reporting or other purposes.

Sub-Account Interface 221 may also use information from Allocation Engine 223 to accurately allocate shares gained as a result of stock splits, mergers, acquisitions, and the like; to reinvest proceeds from sales, dividend payments, or other income sources based on customer preferences; to allow customers to make cash withdrawals from an account; to transfer funds from an existing securities account; and other such purposes. In addition, as certain events occur, for example, specific or customizable calendar dates, specific or customizable periods of time, or customer requests, Sub-Account Interface 221 may also generate printed and/or electronic reports and other documentation. Examples of documentation that may be created by Sub-Account Interface 221 are account activity reports; income tax forms; annual reports, tender offers, and other shareholder communications; and the like.

These reports and functions are available through an on-line interface, which can also allow other means of fund management and/or review. In a preferred embodiment, a customer visits a secure website, where a usemame and corresponding password may be entered for authentication purposes.

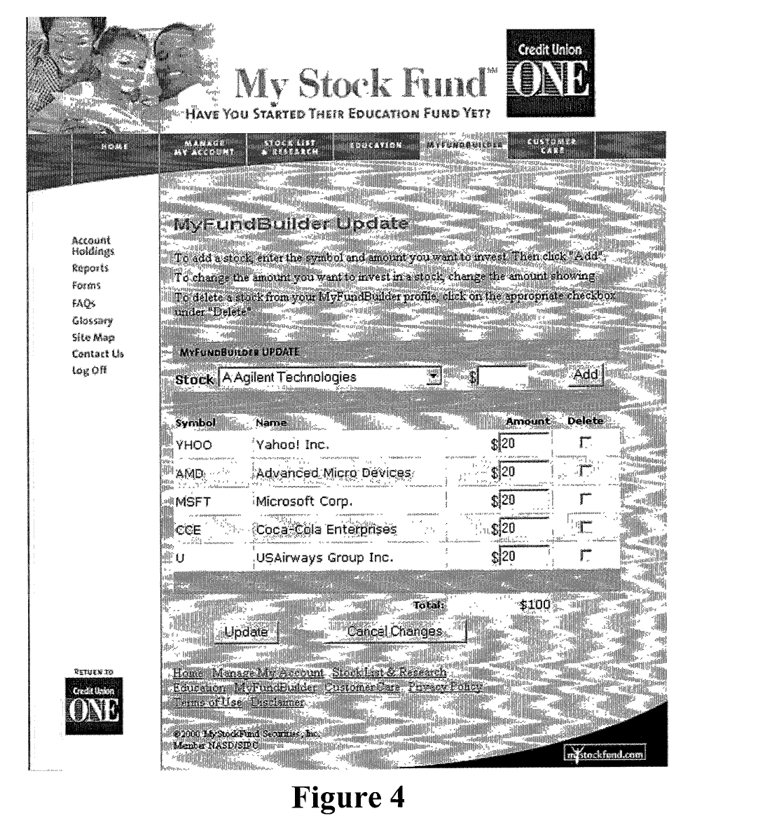

FIGS. 4 through 6 are representative samples of interfaces which may be presented to a customer as an account is created, securities are purchased, and various account preferences are configured.

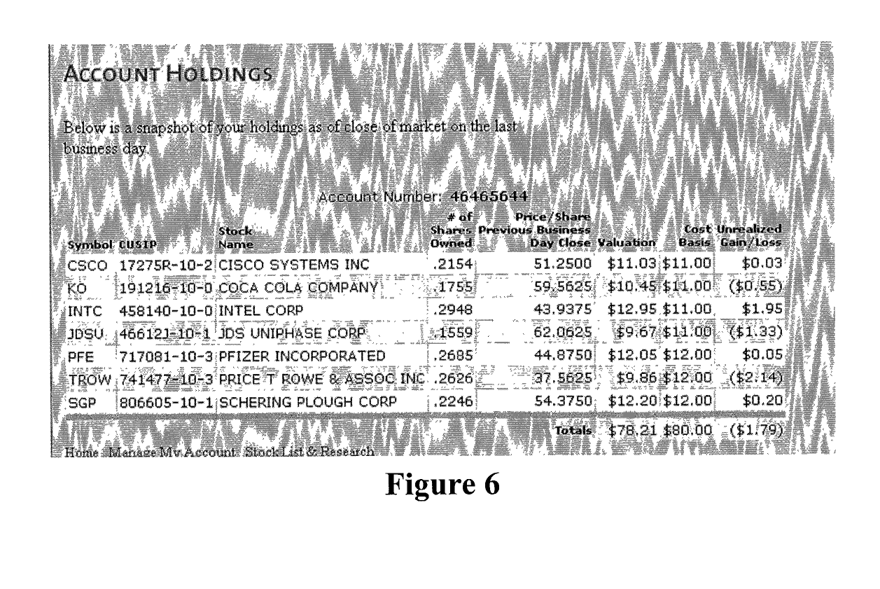

If authenticated, a customer may be presented with an account report similar to FIG. 6. An account report may, for each company whose stock a customer owns, list numbers of whole or fractional shares owned, current share values, and a total value of all shares owned. An account report may also include a total portfolio value. If a customer wishes to invest more funds in an account, a button similar to Manage My Account, illustrated in FIG. 6 near the words “Home” and “Stock List & Research”, may be selected.

Selecting Manage My Account may cause an interface similar to FIG. 4, “MyFundBuilder Update” to be presented. MyFundBuilder Update may be modified, or an alternate interface may also be available, to allow a customer to purchase securities through a more traditional, per-share approach, in addition to a dollar-based approach as illustrated in FIG. 4. MyFundBuilder Update may allow a customer to select a company or companies in which to invest, fill in an amount to be invested in each company, and execute a purchase.

Executed customer purchases may be transmitted from Browser 213 to Sub- Account Interface 221 (illustrated in FIG. 2) through Dollar/Fractional Interface 211 or Whole Share Buy/Sell Orders 212. Sub-Account Interface 211 may generate a notice confirming receipt of an executed transaction. A confirmation receipt may be delivered to a customer through Block 260; a report similar to FIG. 6 may also be shown.

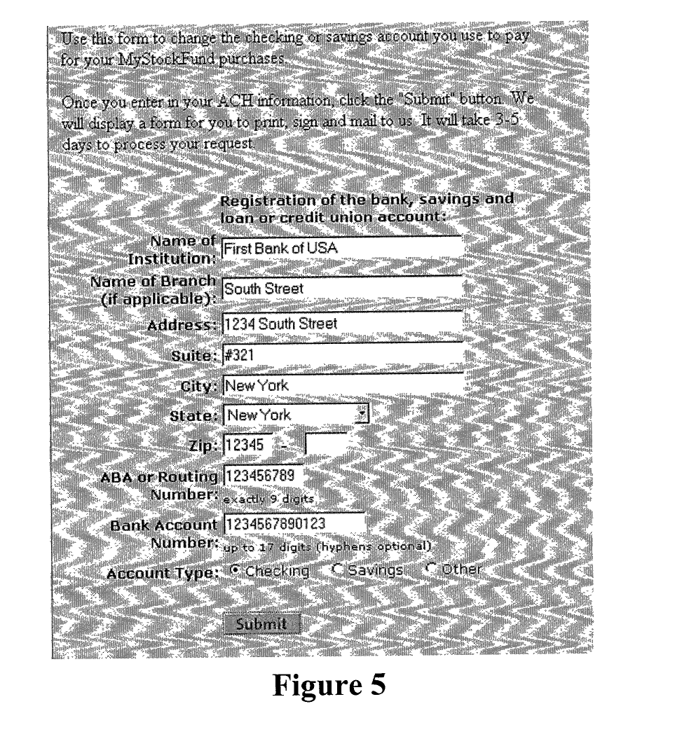

A customer may prefer to schedule automatic withdrawals from a bank account or from payroll; in addition, a customer may wish to have dividends reinvested, or paid as cash. In a preferred embodiment, a customer may indicate these and other preferences through an interface similar to FIG. 5. Once a customer has configured various options, a button similar to Submit, illustrated near the bottom of FIG. 5, may be selected. Selecting Submit, or a button similar to Submit, may store preference settings to Database 150, illustrated in FIG. 1.

While a preferred embodiment and various alternative embodiments of the invention have been disclosed and described in detail herein, it will be apparent to those skilled in the art that various changes in form and detail may be made therein without departing from the spirit and scope thereof. For example, access to account information and account functions may be given through other electronic means, including, but not limited to, Dial Tone Multi-Frequency (DTMF) enabled telephone access, web enabled phones, Personal Digital Assistants (“PDA's”), and other wired or wireless devices, including those supporting the Wireless Application Protocol (“WAP devices”).

The embodiments of the invention in which an exclusive property or privilege is claimed are defined as follows:

1. An electronic system for creating personalized securities funds comprising:
a user interface for receiving selections of securities to be included in a fund;
a securities holding account;
a securities engine which calculates and tracks whole and fractional securities shares owned by an individual investor;
an accounting engine which calculates account balances; and
a reporting engine which generates system-wide and individual investor reports.

2. The system of claim 1 wherein said securities holding account contains all securities maintained by the present invention.

3. The system of claim 1 wherein said securities holding account contains whole and fractional securities not owned by individuals using the present invention and which have yet to be sold off.

4. A method for managing personalized securities funds comprising:
electronically receiving a user's selection of a number of shares or a dollar amount of a given security to be purchased, sold, or transferred;
electronically consolidating and executing buy and sell orders;
electronically calculating whole and fractional shares owned along with fees, dividends, and proceeds of sale; and
reporting results of said calculations to said user.

5. The method of claim 4 wherein said consolidating and executing occur in real time.

6. The method of claim 4 wherein said consolidating and executing occur as a result of a condition being met.

7. The method of claim 6 wherein said condition comprises the passing of a given period of time.

8. The method of claim 6 wherein said condition comprises the accumulation of a number of buy and sell orders.

9. The method of claim 4, further comprising making said reports available to said user in real time. The method of claim 4, further comprising generating periodically, as a result of a condition.

10. The method of claim 10, wherein said condition comprises the passing of a given period of time.

11. The method of claim 10, wherein said condition comprises the accumulation of a number of buy and sell orders.

12. The method of claim 4 wherein said reports include transaction confirmations, income tax statements, annual reports, and other such shareholder communications.
